(19) United States
(12) Patent Application Publication
(10) Pub. No.: US 2015/0025831 A1
(43) Pub. Date: Jan. 22, 2015

(54) DYNAMICALLY UPDATING A TIME INTERVAL OF A GPS

(71) Applicant: Hewlett-Packard Development Company, L.P., Fort Collins, CO (US)

(72) Inventors: Devin Alexander Mourey, Albany, OR (US); Dennis T. So, Corvallis, OR (US); Pavel Kornilovich, Corvallis, OR (US); David M. Cook, Corvallis, OR (US)

(73) Assignee: Intellectual Property Administration, Fort Collins, CO (US)

(21) Appl. No.: 13/943,727

(22) Filed: Jul. 16, 2013

(51) Int. Cl. G04F 5/04; G01V 1/00; G04R 20/02; G01K 3/10

(52) U.S. Cl. CPC G04F 5/04; G01K 3/10; G01V 1/003; G04R 20/02
USPC 702/130

(57) ABSTRACT

A seismic system includes a wireless sensor node. The wireless sensor node includes a global positioning system (GPS) device to receive a GPS time value at an interval; a temperature sensor to measure temperature; an oscillator to measure time; and a memory to store the GPS time value, the temperature, and the oscillator time. The wireless sensor node also includes a processor to determine a rate of temperature change during the interval, and to dynamically update the interval to receive the GPS time value from the GPS device, based on the rate of temperature change.

### BACKGROUND

Global positioning system (GPS) is a space-based satellite navigation system that provides location and time information in all weather conditions, anywhere on or near the earth where there is an unobstructed line of sight to four or more GPS satellites. The system provides critical capabilities to military, civil, and commercial users around the world and is maintained by the United States government and freely accessible to anyone with a GPS device/receiver. For example, seismic systems use GPS devices embedded within wireless sensor nodes for timing and synchronization of events recorded by the sensor nodes.

### BRIEF DESCRIPTION OF THE DRAWINGS

The present application may be more fully appreciated in connection with the following detailed description taken in conjunction with the accompanying drawings, in which like reference characters refer to like parts throughout, and in which:

FIG. 1 is a block diagram of a wireless sensor node including a processor for dynamically updating a time interval of a GPS device, according to one example;

FIG. 2 is a block diagram of a wireless sensor node including a processor for dynamically updating a time interval of a GPS device, according to one example;

FIG. 3 is a flowchart of method for dynamically updating a time interval of a GPS device, according to one example;

FIG. 4 is a flowchart of a method for dynamically updating a time interval of a GPS device, according to one example; and

FIG. 5 is a block diagram of a wireless sensor node including a computer-readable medium with instructions for dynamically updating a time interval of a GPS device of the wireless sensor node, according to one example.

### DETAILED DESCRIPTION

A seismic system for conducting seismic surveys requires time synchronization across a plurality of wireless sensor nodes to achieve high accuracy. Seismic systems are often positioned across a geographical region for a period of time (e.g., several days or weeks) to collect data that are subsequently processed to determine the structure of the earth at the geographical region. Thus, high accuracy seismic systems that have low power consumptions are desired. A wireless sensor node of a seismic system includes an oscillator/clock to measure time. However, an error (or drift) in the clock may occur due to temperature changes in the geographical location and/or due to aging of the clock.

In seismic systems and other such systems that use accurate timekeeping, GPS disciplined clocks are used to account for clock variations and drifts cause by temperature or aging of the clock. GPS disciplined clock works by disciplining (or steering) a local oscillator (i.e., local clock) by locking the output of the clock to a GPS signal via a tracking loop, thus compensating for the phase and frequency changes of the local oscillator and for effects of aging, temperature, and other environmental changes. However, GPS disciplined clocks utilize a significant amount of the total power of the system, resulting in an increased cost of the system due to the cost of the clock and the cost and weight of batteries power source) required to power the wireless sensor node. Thus, having a GPS device/receiver permanently turned on in systems that require accurate timekeeping is an undesirable power drain. Moreover, use of atomic clocks to ensure accuracy of the time would add unreasonable expense, size, and power costs.

Accordingly, examples disclosed herein provide a solution dynamically update the time interval of a GPS device of a system (e.g., a seismic system) to minimize power consumption of the GPS device and the system) and to reduce cost (e.g., compared to using an atomic clock). The described solution utilizes a temperature sensor embedded in a wireless sensor node of the system to determine the rate of temperature change which is used to dynamically optimize the GPS update and to increase synchronization accuracy of the local oscillator/clock.

In one example, a seismic system includes a wireless sensor node. The wireless sensor node includes a GPS device to receive a GPS time value at an interval, a temperature sensor to measure temperature, an oscillator (e.g., clock) to measure time, and a memory to store the GPS time value, the temperature, and the oscillator time. The wireless sensor node also includes a processor to determine a rate of temperature change during the interval, and to dynamically update the interval to receive the GPS value from the GPS device based on the rate of temperature change.

In another example, a method for dynamically updating a GPS time interval includes storing a GPS time value received from a GPS device at the interval, storing temperature measurement received from a temperature sensor, and storing time measurement received. from an oscillator. The method also includes determining a rate of temperature change at the interval, and dynamically updating the interval of the GPS device based on the rate of temperature change.

In another example, a non-transitory computer-readable storage medium includes instructions that when executed by a processor of a wireless sensor node, causes the processor to receive GPS time stamps from a GPS device at a time interval, receive temperature measurements from a temperature sensor corresponding to the time interval, and receive time measurements from an oscillator corresponding to the time interval. The instructions are executable to determine a rate of temperature change during the interval, and dynamically update the time interval to receive the GPS time stamps from the GPS device based on the rate of temperature change, where the GPS device is placed in a low power state when the GPS device is not providing time stamps.

As used herein a “seismic system” is a system of accelerometers, communication devices, computers, and alarms devised for detecting the likely strength and progression, and prediction of seismic events such as earthquakes. As used herein “wireless sensor node(s)” includes spatially distributed sensors to monitor physical or environmental conditions such as temperature, sound, pressure, etc., and to cooperatively pass their data through a network to a main location. The wireless sensor node may include a GPS device, temperature sensor, an oscillator, a memory, and a processor, for example. As used herein “an interval,” “a GPS time interval,” or “a time interval” is a time period or duration for a device (e.g., a GPS device) to power on (or exit a sleep mode/low power mode) to record data. For example, the interval may be every “A” seconds, minutes, or hours, where “A” is a real number. As used herein “GPS time value” or “GPS time stamp” is a signal received by a GPS device from a plurality of GPS satellites that provides a time reference or GPS time. By definition, the GPS time is the number of seconds since 00:00:00 UTC (coordinated universal time), Jan. 6, 1980. As used herein an “oscillator” is a circuit that uses the mechanical resonance of a vibrating crystal of a piezoelectric material to create an electric signal with a precise frequency commonly used to keep track of time, to provide a clock signal for digital integrated circuits, and to stabilize frequencies for radio transmitters and receivers.

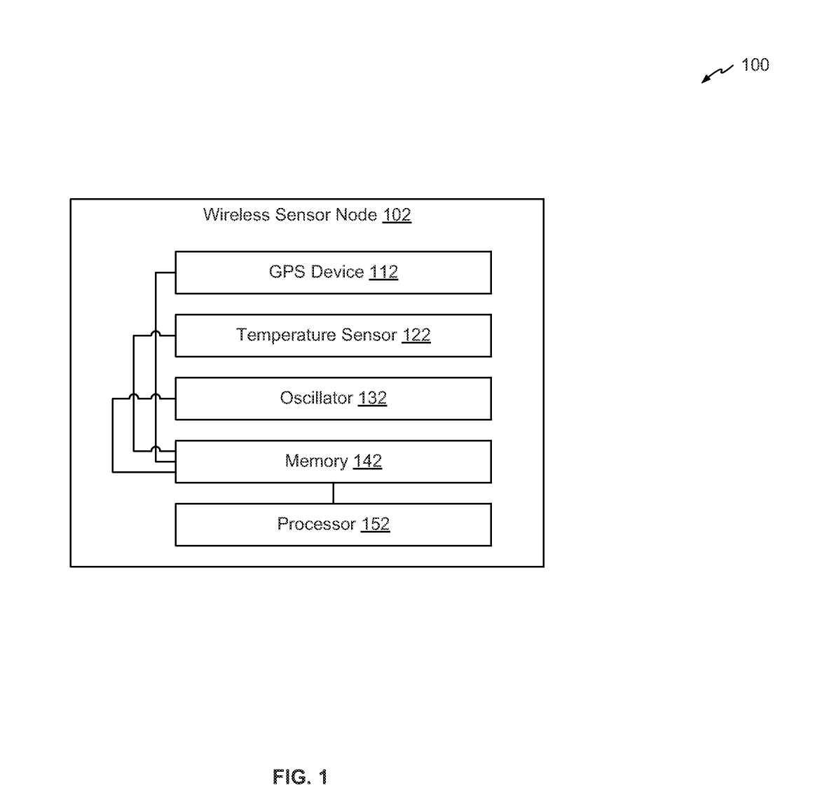

With reference to the figures, FIG. 1 is a block diagram of a wireless sensor node including a processor for dynamically updating a time interval of a GPS device, according to one example. Wireless sensor node 102 can be part of a system 100 (e.g., a seismic system) that requires accurate time keeping by a local clock (e.g., oscillator 132). For example, seismic system 100 may include a plurality of wireless sensor nodes 102 that are placed in a geographic region to record data related to the seismic activity of the geographical region over a period of time (e.g., days, weeks, or months). The data recorded may be stored in the memory 112 and processed by the processor 152. Moreover, the data may be transmitted to a backend server (not shown) via a wireless interface (not shown) for further processing.

Wireless sensor node may therefore include a temperature sensor 122 to measure temperature of the geographical region. Temperature measurements may be Fahrenheit, Celsius, or any other unit of temperature measurement. Oscillator 132 may be at least one of a voltage-controlled crystal oscillator (VCXO), a temperature-compensated crystal oscillator (TCXO), any other crystal oscillator or clock embedded in the wireless sensor node to record time. The frequency of the oscillator may drift over time due to aging and other environmental factors such as temperature changes. Accordingly, GPS device 112 may be provided in the wireless sensor to synchronize the oscillator time and to provide accurate time measurement.

GPS device 112 can include a GPS receiver to receive time reference (i.e., GPS signal) from a plurality of GPS satellites. Thus, the GPS device 112 can serve as an accurate time clock, because the GPS device 112 is less susceptible to the factors aging and environmental factors that may affect the oscillator 132. On the one hand, it may be ideal for the GPS device 112 to receive time value or time stamps at a high rate due to achieve maximum time accuracy due to changes in the oscillator 132. However, this requires the GPS device 112 to be turned or powered on continuously which requires significant power. On the other hand, the GPS device 112 may be turned on at a fixed interval to receive time stamps (e.g., every 15 minutes). However, this solution also does not result in optimized power consumption.

Wireless sensor node 102 also includes a processor 152 to process one or more of the data provided by the GPS device 112, temperature sensor 122, and oscillator 132, and data stored in Memory 142. Processor 152 may be a general purpose processor or a microprocessor, for example. Processor 152 is configured to leverage the temperature readings provided by the temperature sensor 122 to dynamically update the time interval of the GPS device 112 to optimize power consumption of the GPS device 112 based on the rate of temperature change. Thus, the GPS device 112 is placed in a low power state or turned off when the (WS device 112 is not providing GPS time stamps/values to conserve power. For example, the time interval may be increased when the rate of temperature change is below a threshold, and the interval may be decreased when the rate of temperature change is above the threshold.

During operation of the wireless sensor node 102, for example, in initial interval may be chosen for the GPS device 112. For example, the GPS device 112 may be powered on to receive GPS time stamps every 2 minutes. Thus, the initial interval of the GPS device 112 may be set to a predetermined value. The oscillator 132 may be powered on continuously to measure time. For example, the oscillator 132 may drive a local counter which is not adjusted but is free running during operation. At the time interval of the GPS device 112, the GPS time value and an associated oscillator time value are stored in the memory 142. Memory 142 may be volatile or non-volatile storage media.

Temperature is measured by the temperature sensor 122 and stored to memory 142 with less frequency (e.g., less than 10 seconds), thereby consuming low power. Accordingly, the temperature measurement corresponding to or associated with the GPS time interval is known. As temperature is measured and stored, the processor 152 can determine the rate of temperature change, for example, by using a moving average technique. The rate of temperature change is then correlated to the predefined GPS time interval to dynamic adjustment. The rate of temperature change is compared to a threshold to determine whether the rate of temperature change is high or low. For example, the threshold may be predetermined and stored in memory. Alternately, the threshold may be based on historical data such as time error of the clock at certain temperatures.

Accordingly, if the rate of temperature change is determined to be high (i.e., above the threshold), the GPS time interval may be reduced (e.g., the GPS device 112 is powered on more often to receive time stamps). However, if the rate of temperature change is determined to be low below the threshold), the GPS time interval may be increased (e.g., the GPS device 112 is powered on less often to receive time stamps). Thus, more GPS time stamps arc captured during periods of high temperature change and less GPS time stamps are captured during periods of low temperature change, thereby reducing power consumption while maintaining accurate time keeping.

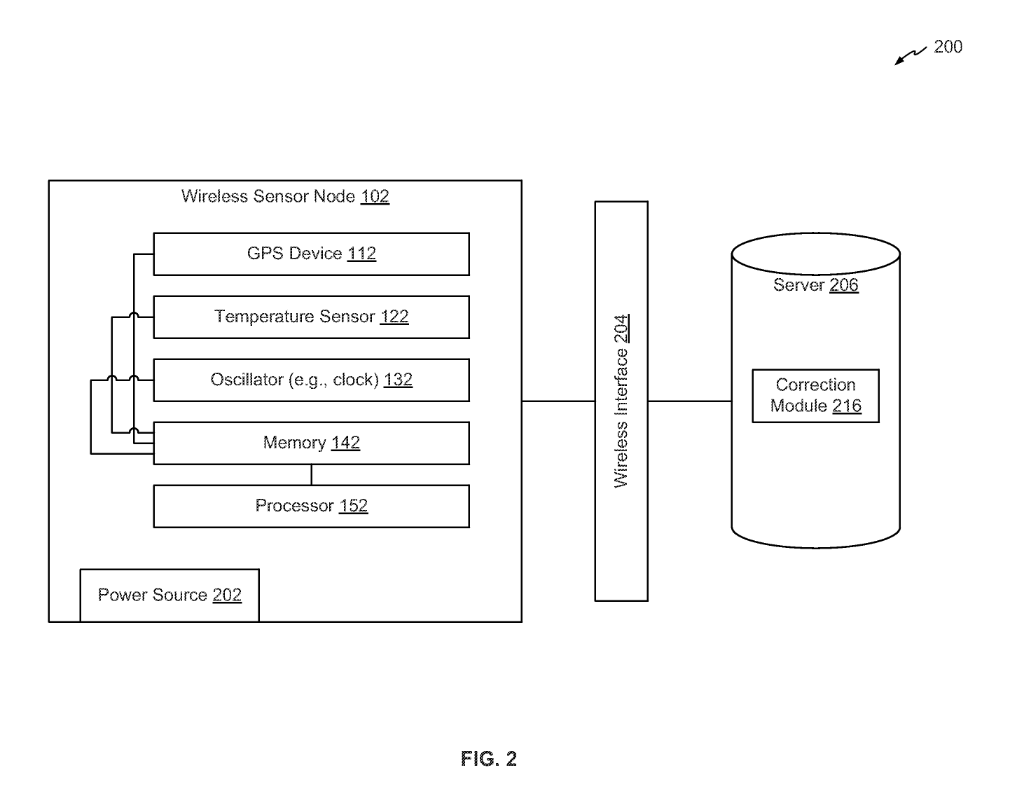

FIG. 2 is a block diagram of a wireless sensor node including a processor for dynamically updating a time interval of a GPS device, according to one example. In the example of FIG. 2, seismic system 200 includes the wireless sensor node 102, a wireless interface 204, and a server 206.

Wireless sensor node 102 includes the GPS device 112, the temperature sensor 122, the oscillator 132, the memory 142, the processor 152, and a power source 202. Power source 202 may be a battery pack or any other power source to power the components 112-152 of the wireless sensor node 102. Wireless interface 204 may be any hardware/software to move data from the node 102 to the data processing server 206. For example, wireless interface 204 can be wireless local area network (WLAN), a wireless mesh network, wireless metropolitan area network (WMAN), a cellular network, or any other wireless network for transferring data from the Bode 102 to the server 206.

During operation of the node 102 data values provided by the GPS device 112, the temperature sensor 122, and the oscillator 132 are stored in the memory 142. For example, the GPS device 112 is powered on at an initial interval (e.g., every 2 minutes) to receive GPS time stamps. Each time the GPS device 112 powers on to receive the GPS time stamps, associated oscillator time values are recorded and stored in memory 142. The oscillator 132 measure time continuously during operation of the node 102. Further, temperature measurements from the temperature sensor 122 are received with a larger time interval (e.g., every 10 seconds) and stored in memory 142. Processor 152 computes the rate of temperature change (e.g., using a moving average technique) based on the stored temperature measurements of the temperature sensor 122. The rate of temperature change is compared to a threshold to determine by how much the GPS time interval is to be dynamically adjusted. For example, if the rate of temperature change is below the threshold, the GPS time interval is increased. However, if the rate of temperature change is above the threshold, the GPS time interval is decreased. Accordingly, the on and off time of the GPS device is dynamically adjusted to optimize power consumption of the GPS device 112.

In addition, the processor 152 can compare the oscillator time value to the GPS time value during an interval to determine an error or drift/variation in the oscillator time cause by changes in temperature. The determined error value of the oscillator time is stored in memory 142. The processor 152 can initiate the transmission of the data stored in the memory 152 to the server 206 via the wireless interface 204. The server 206 may be a backend office or monitoring office. Further, the server 206 may include a correction module 216 to correct for time shifts and skew error in the oscillator time. For example, correction module may be hardware and/or software to correct the oscillator time using the error value determined by the processor 152. Accordingly, at the server 206, an error of the oscillator 132 at a particular time interval is corrected. It should be noted that comparison (and correction) of the oscillator time with the GPS time (i.e., based on the differences in the oscillator time and the GPS time) is performed at the server 206, to reduce power consumption at the node 102. The node 102 is configured to dynamically adjust the acquisition rate of the GPS device 112 to farther reduce power consumption at the node 102.

In another example, GPS time stamps/values may be estimated for missing GPS time stamps/values where the GPS device 112 is unable to receive GPS signals. To illustrate, at one or more particular intervals of the UPS device 112, the GPS device 112 may be unable to receive signal due to environmental conditions and thus no GPS data values are stored in the memory 142. Accordingly, during such intervals of missing GPS values, the UPS values can be estimated based on a combination of the rate of temperature change and the oscillator time at such intervals. For example, correlation techniques can be used to obtain a GPS value at a particular interval based on the rate of temperature change and the oscillator time at the particular interval. For example, historical data relating the rate of temperature change to the drift of the oscillator time may be used to estimate what the UPS time value is at the particular interval. To illustrate, if historical data shows that when the temperature change is above a threshold, the oscillator time drifts by a certain amount of time (i.e., the error value), the GPS time value corresponding to the oscillator time may be estimated.

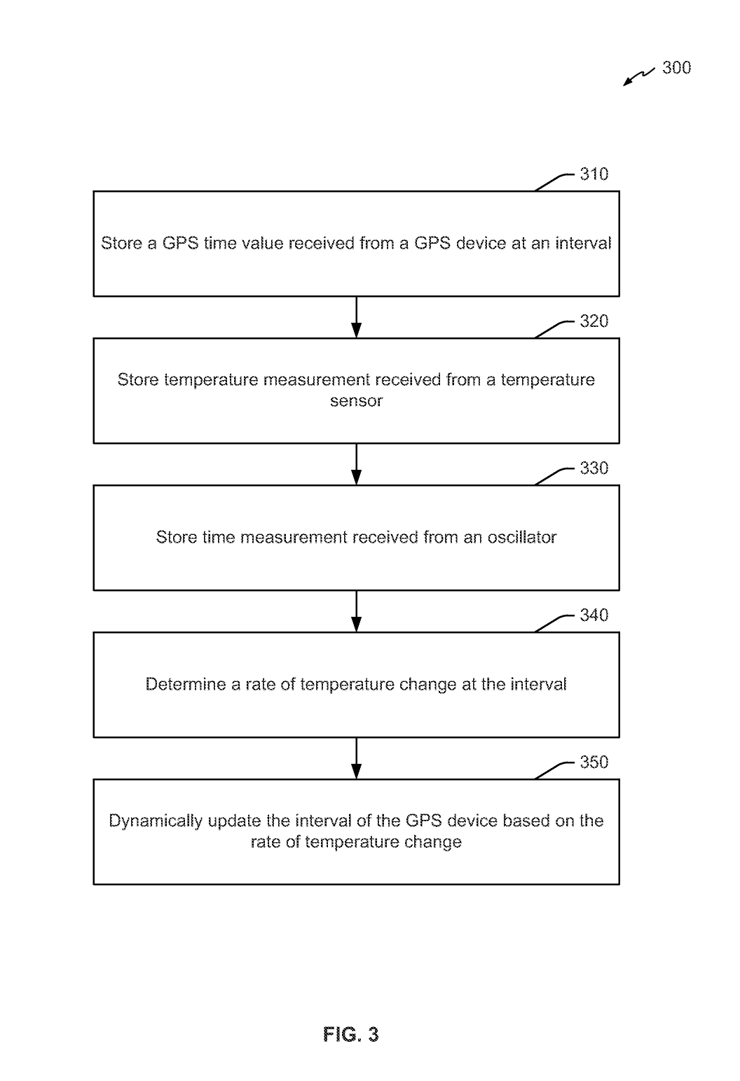

FIG. 3 is a flowchart of a method for dynamically updating a time interval of a GPS device, according to one example. Method 300 may be implemented in the form of executable instructions stored on a non-transitory computer-readable storage medium and/or in the form of electronic circuitry.

Method 300 includes storing a GPS time value received from a GPS device at an interval, at 310. For example, GPS time value provided by the GPS device 112 may be stored in memory 142. The GPS device 112 may be initially set to a predefined interval of ‘x’ seconds or minutes, where ‘x’ is a real number. The initial interval of the GPS device 112 may be 1 to 10 seconds, for example.

Method 300 includes storing temperature measurement received from a temperature sensor, at 320. For example, temperature measurements provided by temperature sensor 122 may be stored in memory 142. Temperature sensor 122 may be programmed to provide temperature measurements at a frequency of less than 10 seconds, for example.

Method 300 includes storing time measurement received from an oscillator, at 330. For example, time measurements provided by the oscillator 132 may be stored in memory 142. Oscillator 132 may continuously provide time measurements. Thus, oscillator 132 tracks time continuously.

Method 300 includes determining a rate of temperature change at the interval, at 340. For example, processor 152 may determine the rate of temperature change during the interval. For example, if the initial interval of the GPS device 112 is 5 seconds, the processor 152 can determine the rate of temperature change between the temperature measurement at 5 seconds and the temperature measurement at 10 seconds, and so on.

Method 300 includes dynamically updating the interval of the GPS device based on the rate of temperature change, at 350. For example, the processor 152 can dynamically update the time interval of the GPS device based on the rate of temperature change. To illustrate, if the rate of temperature change is below a threshold, the interval increased, and if the rate of temperature change is above the threshold, the interval is decreased. Thus, the initial interval of 5 seconds (in the example above) may be dynamically increased to 10 seconds if the rate of temperature change is below the threshold, for example. Likewise, the initial interval of 5 seconds may be dynamically decreased to 1 second if the rate of temperature change is above the threshold, for example.

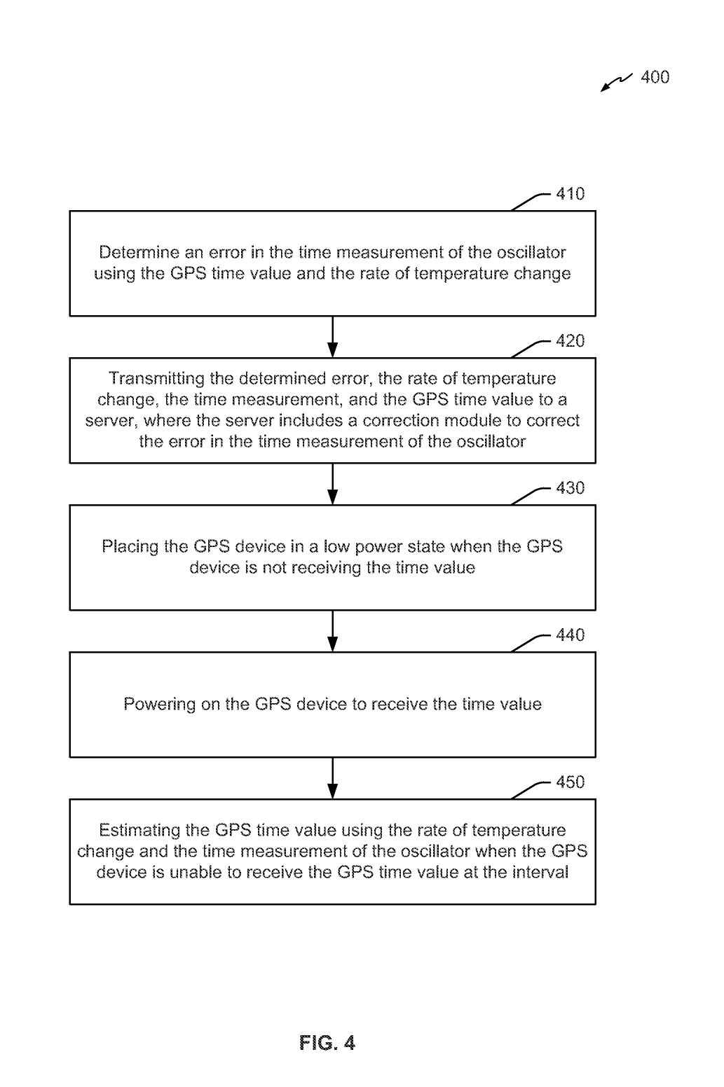

FIG. 4 is a flowchart of a method for dynamically updating a time interval of a GPS device, according to one example. Method 400 may be implemented in the form of executable instructions stored on a non-transitory computer-readable storage medium and/or in the form of electronic circuitry.

Method 400 includes determining an error in the time measurement of the oscillator using the GPS time value and the rate of temperature change, at 410. In one example, the GPS time value provided by the GPS device 112 and the computed rate of temperature change are used to determine how much error is introduced to the oscillator time due to the temperature change. In another example, the error may be determined at a backend server of the seismic system.

Method 400 includes transmitting the determined error, the rate of temperature change, the oscillator time measurement, and the GPS time value to a server, where the server includes a correction module to correct the error in the oscillator time measurement, at 420. For example, the data (i.e., values) derived from the components 112-132 and stored in the memory 142 are transmitted to the server 206 via the wireless network 204, where a correction module 216 of the server 206 corrects the error in the oscillator 132.

Method 400 includes placing the GPS device in a low power mode when the GPS device is not receiving the time value, at 430, and powering on the GPS device to receive the time value, at 440. For example, the GPS device 112 is placed in a power saving mode before and after the interval (i.e., outside of the interval) when the GPS device is not collecting GPS time values/stamps to conserve power.

Method 400 includes estimating the GPS time value using the rate of temperature change and the oscillator time measurement when the GPS device is unable to receive GPS time value at the interval, at 450. For example, if the GPS device 112 is not receiving GPS signals from a plurality of GPS satellites and is thus unable to provide GPS time values, the missing time values may be estimated based on the rate of temperature change and oscillator time measurement.

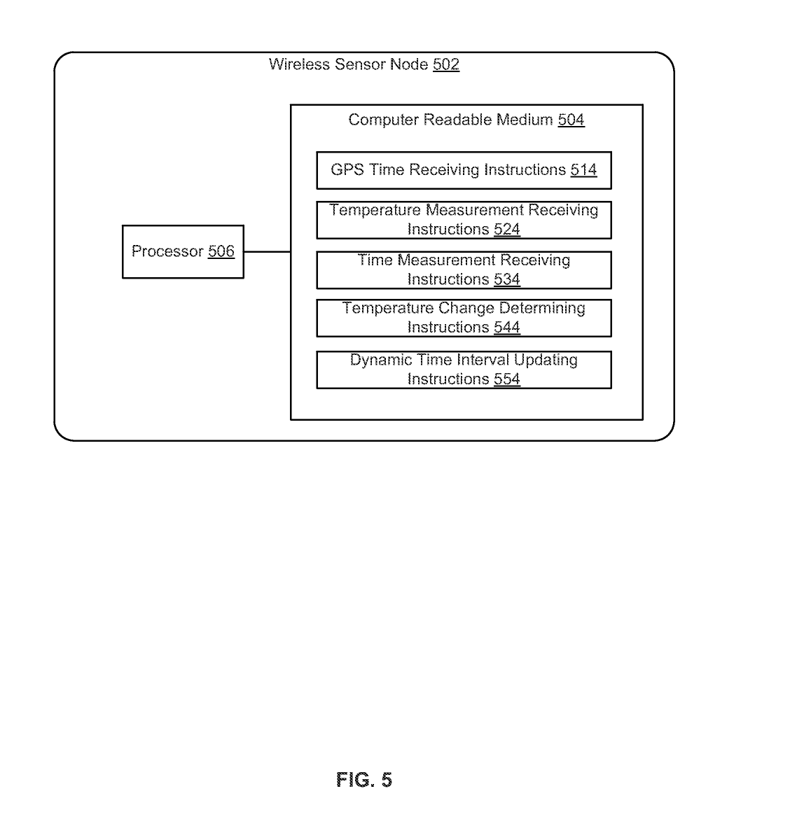

FIG. 5 is a block diagram of a wireless sensor node including a computer-readable medium with instructions for dynamically updating a time interval of a GPS device, according on one example. The node 502 can include non-transitory computer-readable medium 504. The medium 504 can include instructions 514-554 that, if executed by a processor 506, can cause the processor to dynamically update the time interval of a GPS device of the node 502.

For example, GPS time receiving instructions 514 are executable to receive GPS time stamps from a GPS device at a time interval. Temperature measurement receiving instructions 524 are executable to receive temperature measurements from a temperature sensor corresponding to the time interval. Time measurement receiving instructions 534 are executable to receive time measurements from an oscillator corresponding to the time interval. Temperature change determining instructions 544 are executable to determine a rate of temperature change during the time interval. Dynamic time interval updating instructions 554 are executable to dynamically update the time interval to receive the GPS time stamps from the GPS device, based on the rate of temperature change, where the GPS device is placed in a low power state when the GPS device is not providing time stamps.

The examples described above may be embodied in a computer-readable medium for configuring a computing system to execute the method. The computer-readable media may include, for example and without limitation, any number of the following non-transitive mediums: magnetic storage media including disk and tape storage media; optical storage media such as compact disk media (e.g., CD-ROM, CD-R, etc.) and digital video disk storage media; holographic memory; nonvolatile memory storage media including semiconductor-based memory units such as FLASH memory, EEPROM, EPROM, ROM; ferromagnetic digital memories; volatile storage media including registers, buffers or caches, main memory, RAM, etc.; and the Internet, just to name a few. Other new and obvious types of computer-readable media may be used to store the software modules discussed herein. Computing systems may be found in many forms including but not limited to mainframes, minicomputers, servers, workstations, personal computers, notepads, personal digital assistants, various wireless devices and embedded systems, just to name a few.

In the foregoing description, numerous details are set forth to provide an understanding of the present invention. However, it will be understood by those skilled in the art that the present invention may be practiced without these details. While the invention has been disclosed with respect to a limited number of examples, those skilled in the art will appreciate numerous modifications and variations therefrom. It is intended that the appended claims cover such modifications and variations as fall within the true spirit and scope of the invention.

What is claimed is:

1. A seismic system comprising:
a wireless sensor node comprising:
a global positioning system (GPS) device to receive a GPS time value at an interval;
a temperature sensor to measure temperature;
an oscillator to measure time; and
a memory to store the GPS time value, the temperature, and the oscillator time; and
a processor to:
determine a rate of temperature change during the interval; and
dynamically update the interval to receive the GPS time value from the GPS device based on the rate of temperature change.

2. The seismic system of claim 1, wherein power is reduced to the GPS device the GPS device is not receiving the GPS time value.

3. The seismic system of claim 1, the processor is to:
compare the temperature change with a threshold value;
increase the GPS interval when the rate of temperature change is below the threshold; and
decrease the GPS interval when the rate of temperature change is above the threshold.

4. The seismic system of claim 1, the memory to store an oscillator time value associated with the GPS time value at the interval.

5. The seismic system of claim 4, the processor is to:
compare the oscillator time value with the GPS time value at the interval;
determine an error value of the oscillator time value caused by a change in the temperature; and
initiate transmission of the oscillator time value, the GPS time value, and the error value to a server via a wireless interface, wherein the seismic system includes the server and the wireless interface.

6. The seismic system of claim 5, the server comprising a correction module to correct the oscillator time value using the error value.

7. The seismic system of claim 6, wherein the threshold is determined based on a value of the error.

8. The seismic system of claim 1, wherein the oscillator includes at least one of a temperature-compensated crystal oscillator (TCXO) and a voltage-controlled crystal oscillator (VCXO).

9. The seismic system of claim 1, wherein power is enabled to the GPS device at the time interval to receive the GPS time value, and wherein power is reduced to the GPS device after the interval.

10. The seismic system of claim 1, wherein when the GPS device is unable to receive the GPS time value at a particular interval, the processor is to estimate the GPS time value at the particular interval based on the rate of temperature change and the oscillator time value at the particular interval.

11. A method for dynamically updating a global positioning system (GPS) time interval, comprising:
storing a GPS time value received from a GPS device at the interval;
storing temperature measurement received from a temperature sensor;
storing time measurement received from an oscillator;
determining a rate of temperature change at the interval; and
dynamically updating the interval of the GPS device based on the rate of temperature change.

12. The method of claim 11, comprising:
determining an error in the time measurement of the oscillator using the GPS time value and the rate of temperature change; and
transmitting the determined error, the rate of temperature change, the time measurement, and the GPS time value to a server wherein the server includes a correction module for correcting the error in the time measurement of the oscillator.

13. The method of claim 12, wherein dynamically updating the interval comprises:
increasing the interval when the rate of temperature change is below a threshold; and
decreasing the interval when the rate of temperature change is above the threshold.

14. The method of claim 13, wherein the threshold is based on the error.

15. The method of claim 11, comprising placing the GPS device in a low power state the GPS device is not receiving the time value.

16. The method of claim 11, comprising powering on the GPS device to receive the time value.

17. The method of claim 11, comprising estimating the GPS time value using the rate of temperature change and the time measurement of the oscillator, when the GPS device is unable to receive the GPS time value at the interval.

18. A non-transitory computer-readable storage medium comprising instructions that, when executed by a processor of a wireless sensor node, causes the processor to:
receive global positioning system (GPS) time stamps from a GPS device at a time interval;
receive temperature measurements from a temperature sensor corresponding to the time interval;
receive time measurements from an oscillator corresponding to the time interval;
determine a rate of temperature change during the time interval; and
dynamically update the time interval to receive the GPS time stamps from the GPS device based on the rate of temperature change, wherein the GPS device is placed in a low power state when the GPS device is not providing time stamps.

19. The non-transitory computer-readable medium of claim 18, wherein the instructions are executable to:
determine an error in the time measurements of the oscillator based on the GPS time stamps and the rate of temperature change; and
initiate transmission of the GPS time stamps, temperature measurements, oscillator time measurements, and error to a server, wherein the server includes a correction unit to correct the oscillator time measurements based on the determined error.

20. The non-transitory computer-readable medium of claim 18, wherein the instructions are executable to estimate the GPS time stamps based on the rate of temperature change and the oscillator time measurements, when the GPS device is unable to provide GPS time stamps.
